(19) United States
(12) Patent Application Publication
(10) Pub. No.: US 2014/0366428 A1
(43) Pub. Date: Dec. 18, 2014

(54) Trap for Flying Insects, the Use of Said Trap and Corresponding Manufacturing Method

(71) Applicant: PROBODELT, S.L., Tarragona (ES)

(72) Inventors: Joan Evangelista Ramoneda Molins, Tarragona (ES); Jordi Roig Reverte, Tarragona (ES)

(21) Appl. No.: 14/119,004

(22) PCT Filed: May 29, 2012
(86) PCT No.: PCT/ES2012/070393

§ 371 Date: Nov. 20, 2013

(30) Foreign Application Priority Data
Jun. 1, 2011 (ES) P201130907

(51) Int. Cl. A01M 1/10

(52) U.S. Cl. CPC A01M 1/106
USPC 43/122; 493/390

(57) ABSTRACT

A method distinguishes electrical signals corresponding to an activation or deactivation of a single electrical power consuming device from an electrical signal that supplies electricity to multiple electrical power consuming devices has been developed. The method includes generating signatures corresponding to activation and deactivation of a plurality of electrical devices from a transformation of an electrical power signal using sparse deconvolution to cluster and then identify the activation and deactivation of one of the plurality of electrical devices.

### FIELD OF THE INVENTION

The invention relates to a trap for flying insects that includes an inner chamber for confining the insects and that is accessible via at least one access entry suitable for said insects.

The invention also relates to the use of a sheet for manufacturing a trap according to the invention, and to a manufacturing method of the trap of the invention.

In the invention, the concept of a “flying insect” means that the trap is intended for fighting insects in the final stage of their metamorphosis, in which they can already fly. The flying phase is when the insects have reached sexual maturity and therefore reproduce and disperse their population, thereby increasing damage to crops. It is at this stage that insects can result in harmful pests.

### STATE OF THE ART

One of the negative consequences of globalisation includes the ease with which pests of insect can spread. One of the most significant sources of this global spread comes from importing and exporting fruit and vegetables from all over the world, particularly between continents. These transported products can be carriers of exotic insect species or larvae thereof, and be accidentally introduced into the destination countries of such products. Some of these species easily adapt to the new environment and eventually become agricultural pests.

On the other hand, in recent years organic methods of pest control on farms has increased in popularity and, in particular, in fruit-tree farming. The conventional pesticide spraying of farms has been gradually replaced by mass-trapping techniques. Trapping consists of attracting the insect into a confinement chamber of a closed trap by means of using pheromone attractants and/or foodstuffs. Once the insect is on the inside of the chamber, it is difficult for them to find the way out. Furthermore, an insecticide is added to the inside of these traps, being responsible for killing the insect once it has entered the confinement chamber.

Based on documents ES 1074165 and ES 1072529, from this Applicant, traps intended for mass trapping of pests of fruit-eating insects such as Ceratis capitata and Bactrocera oleae, better known as the Mediterranean fruit fly and the olive fruit fly, respectively, are known. This type of trap is particularly effective for mass trapping, but the volume occupied negatively impacts shipping, making it difficult to market in countries that are far from the manufacturer.

### SUMMARY OF THE INVENTION

The invention aims to provide a trap for flying insects that can be manufactured in a single manufacturing facility locally, but used globally at a reasonable cost and all without the traps of prior art becoming less effective. This purpose is achieved by means of a trap for insects, characterised in that the chamber is defined by at least one flexible sheet that can be rolled from an open position to a closed position, forming a three-dimensional body that is open at least at one of the ends thereof.

Indeed the configuration of the trap means at least part of the trap is simply a stackable sheet thereby saving space and therefore is easier to transport anywhere in the world at a reasonable cost. The other parts of the trap are made such that they are stackable to minimise the space occupied.

The chamber is preferably defined by a base and a lid, and the base comprises a first flexible sheet provided with first closing means for securing said closed position, and means suitable for forming the access entry to said chamber in said position closed, and the base can be coupled to the lid by means of a first coupling means. These closing means are configured such that the trap can be assembled and disassembled and therefore it can be stored again occupying a small space.

In the invention, the means suitable for forming an access entry relate to an element that make it possible to create an access opening to the inside of the chamber. For example, as will be seen later in the description, the structure of the sheet itself can create this opening. Alternatively, the sheet may be pre-scored so the user can tear off the piece of sheet to access the inner chamber. It can also be an orifice that has been already created on the sheet.

Furthermore, the invention encompasses a number of preferred features which are the object of the dependent claims and the usefulness of which will be highlighted later in the detailed description of an embodiment of the invention.

There are certain species of flying insects, for example, certain flies such as the frugivorous Ceratis capitata and the Dacus oleae which are attracted by brightness. Therefore, the lid preferably comprises a translucent or transparent zone through which external light may enter said chamber. Once the insect has entered the chamber, it will tend to go towards the light and therefore remain in the trap for longer, allowing time for the insecticide to take effect.

Optionally, the base is opaque in order to attract certain types of insects such as flies like the Ceratis capitata or Dacus Oleae, which are attracted to certain colours.

In mass trapping, a large number of traps per hectare of crop should be mounted. To facilitate assembly of the trap according to the invention, the means are preferably at least one entry serving as an entry orifice for insects, being preformed in the first sheet.

It was also found that for certain species of flies such traps are more effective if the entry openings in the inner chamber are a conduit facing the inside of the chamber. These conduits can be retrofitted. Nonetheless, to facilitate the preparation of trapping, it is preferable that the orifice extends to form a frustoconical conduit that protrudes from the main surface of the first sheet. Thus, despite having pre-assembled conduits, the sheet can be stacked easily and the transport volume is reduced. Optionally, the base of the trap according to the invention comprises an upper truncated cone formed by the first sheet which can be coupled to the lid and a lower, hollow, convex portion and the truncated cone and the convex portion are connected by means of a number of second mutual coupling means. In trials conducted for trapping Ceratis capitata it has been found that the concave shapes and particularly the revolving configuration encouraged insects to go near and enter the traps. The lower convex portion, on being hollow and convex, is easily stackable and therefore transportable. Also by having mutual coupling means the trap can be assembled easily.

Particularly preferably, in the transition area between the truncated cone and the convex portion, the side surface of the base is substantially smooth. By substantially smooth, in the invention it is understood that a step greater than the thickness of one of the parts will not be formed.

Preferably, the trap comprises a truncated cone whose smaller base forms an access opening to the chamber and is pointing towards the inside of the chamber. This system has the additional advantage of having a greater surface area for the insects to position themselves before entering the chamber (maximum opening of the truncated cone) without having to increase the size of the lid, with the resulting savings in material and space.

The trap preferably comprises a second cone arranged such that said smaller base of the truncated cone points towards the apex of the second cone and in that the apex of the cone comprises an outlet for liquid and the inner surface of the truncated cone is substantially smooth. It was found that once certain types of insects such as butterflies land on the trap they do not walk very much and are captured when they slide on the smooth slope that leads to a confinement chamber.

In order to further reduce the space occupied by the trap when disassembled, the lid comprises a second flexible sheet that can be rolled, being provided with second closing means for securing the closed position. In this way, the lids can be packaged in an exceptionally compact form as the lid and base are formed by a sheet.

Another object of the invention is to reduce production costs. To that end, the first and second sheets are preferably specularly symmetrical. Thus, the sheets can be made using only one tool prior to assembling the trap.

In another embodiment, the cover is a second flat sheet that can be mounted to the base by means of the aforementioned coupling means, to simplify the way it is manufactured and stored.

In an alternative embodiment, the trap has a second sheet in the shape of a truncated cone whose smaller base forms an access opening to the chamber and is pointing towards the inside of the chamber and further comprises a laminar receptacle. By using the laminar bag-type receptacle, manufacturing the trap and its storage is simplified and production costs are reduced.

Particularly preferably, the trap is made from biodegradable or biocompostable material, which avoids having to collect the traps once the season is over.

The invention also relates to use of a flexible sheet that can be rolled in the manufacture of a trap for flying insects.

Similarly, the invention proposes a method for manufacturing a trap for flying insects that includes an inner chamber for confining the insects and that is accessible to the insects via at least one access entry suitable for said insects. To this end, the method comprises the steps for forming at least a portion of the trap by rolling a flexible sheet from an open position to a closed position to form a three-dimensional body that is open at least at one of the ends thereof.

Preferably, the method comprises a step for fixing said closed position of said sheet by means of a first removable closing means.

Preferably, the trap comprises a base and a lid in the method comprising a number of steps in which the first sheet is rolled into the shape of an upper truncated cone that can be coupled to the lid by means of a first coupling means, and a lower, hollow convex portion is connected to the smaller base of said truncated cone by means of second mutual coupling means.

Preferably, the method further comprises a step for forming the lid by rolling a second flexible sheet from an open position to a closed position to form an open three-dimensional body at least at one of their ends thereof by means of a second closing means for securing said closed position.

Furthermore, the invention also encompasses other detailed characteristics shown in the detailed description of an embodiment of the invention and in the accompanying figures.

### BRIEF DESCRIPTION OF THE DRAWINGS

Other advantages and characteristics of the invention will become apparent from the following description in which, without limitation, preferred embodiments of the invention are explained, with reference to the accompanying drawings. The figures show:

FIG. 1 is a sectioned view of a plurality of first stacked sheets intended for the manufacture of a first embodiment of the trap according to the invention.

FIG. 2 is a top plan view of the first sheet when open.

FIG. 3 is a perspective view of the first embodiment of the trap according to the invention.

FIG. 4 is a longitudinally sectioned view along a central plane of the trap of FIG. 3.

FIG. 5 is a top plan view of the first sheet intended for manufacturing a second embodiment of the invention.

FIGS. 6A and 6B are an enlarged and longitudinally cut view of the sequence of conversion of the means that are suitable for forming a side access entry by inserting an access conduit to the confinement chamber of the trap.

FIG. 7 is a longitudinally sectioned view of the second embodiment of the trap according to the invention in an assembled state.

FIG. 8 is a perspective view of a third embodiment of the trap according to the invention.

FIGS. 9A and 9B are an assembly sequence of the base of the trap of FIG. 8.

FIG. 10 is a longitudinally sectioned view along a central plane of the trap of FIG. 8.

FIGS. 11A and 11B are perspective views of a fourth embodiment of the trap according to the invention.

FIG. 12 is a longitudinally sectioned schematic view along a central plane of a fifth embodiment of the trap according to the invention.

FIG. 13 is a longitudinally sectioned schematic view along a central plane of a sixth embodiment of the trap according to the invention.

FIG. 14 is a longitudinally sectioned schematic view along a central plane of a seventh embodiment of the trap according to the invention.

### DETAILED DESCRIPTION OF A NUMBER OF EMBODIMENTS OF THE INVENTION

Various embodiments of the trap according to the invention are shown hereinafter. These traps 1 are intended for any flying insect, and in particular Diptera and Lepidoptera.

As seen in the figures, the trap for flying insects generally includes an inner chamber 2 for confining the insects and that is accessible via at least one access entry suitable for said insects. In other words, the entry must allow access to the trap 1 but making it difficult for the insects to exit once they are in the chamber 2. As shown in the figures, the chamber 2 is defined by at least one sheet 8, 30 which in some cases forms the lid 6 of the trap 1. In other cases it forms the base 4, and in some embodiments the whole trap 1 is formed using sheets. In all cases, the embodiments show that the sheet 8,30 is flexible and can be rolled from an open position to a closed position, forming a three-dimensional body that is open at least at one of the ends thereof. Thus, in the invention, the sheet must always be developed such that it is substantially flat for easy storage and transportation.

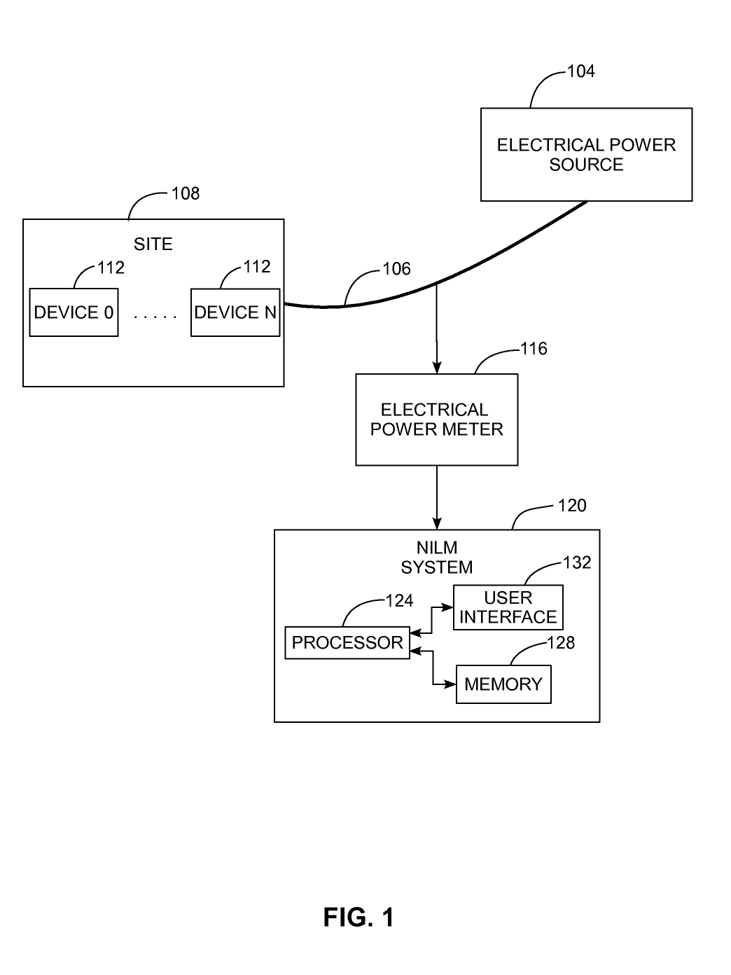

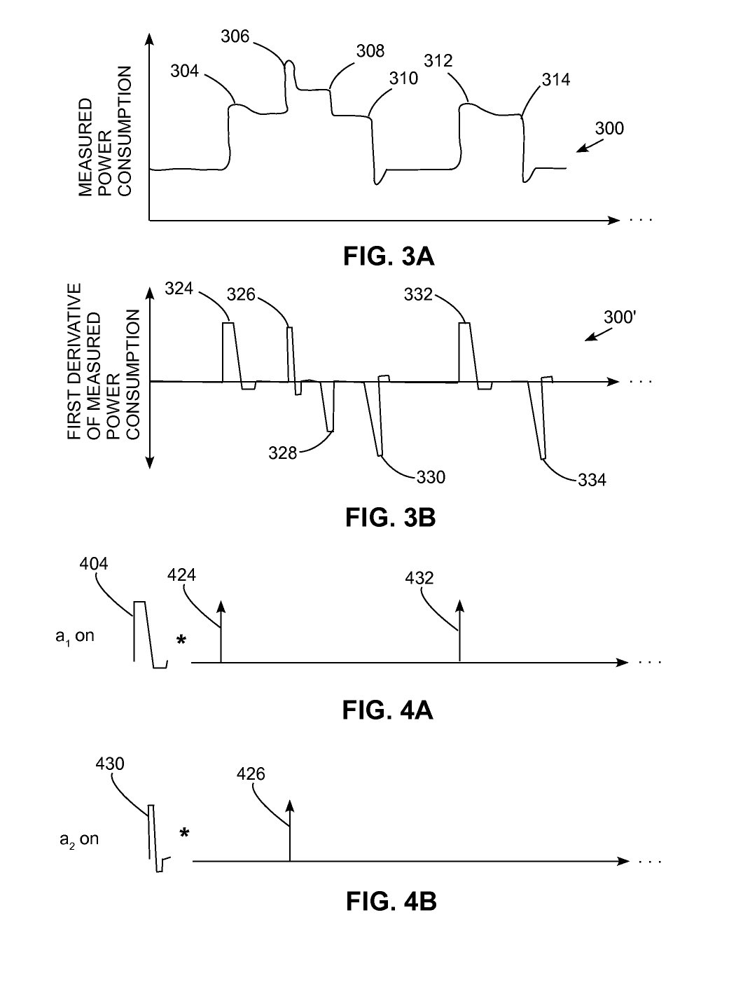

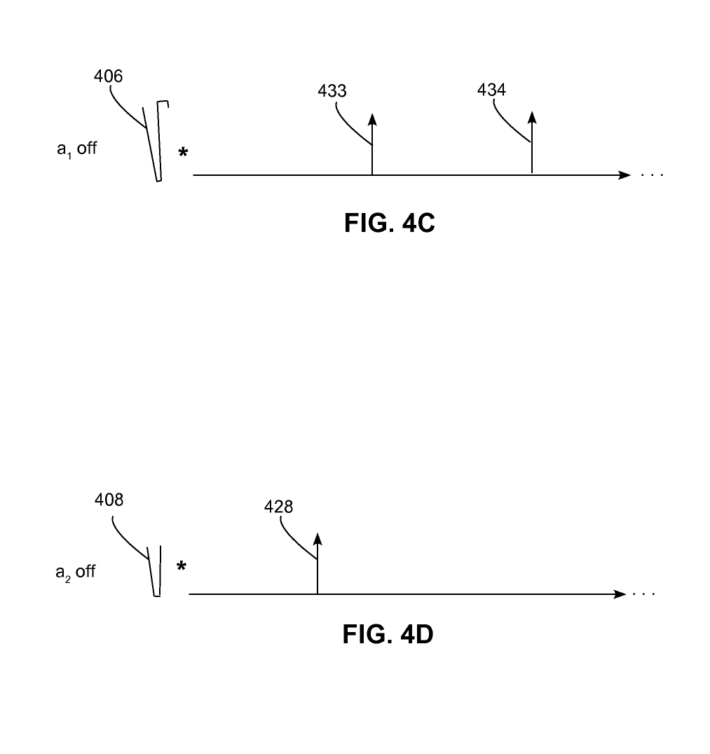

In a first embodiment shown in FIGS. 1 to 4, the trap 1 comprises an inner chamber 2 for confining insects defined by a base 4 and a lid 6.

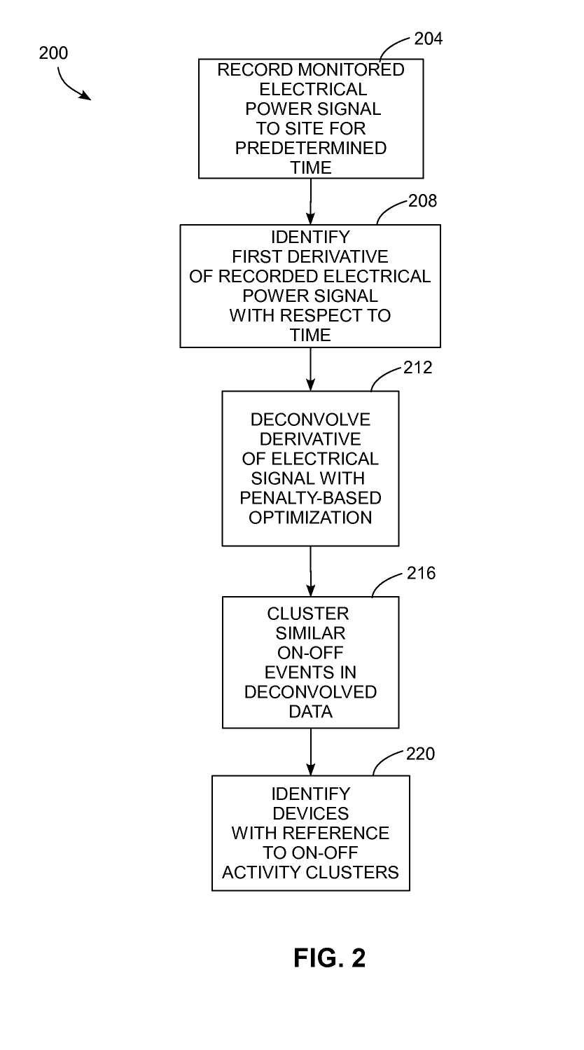

In this case, the base 4 is formed by a first flexible sheet 8 that can be rolled and is provided with a first closing means 12 for securing the closed position. To that this, the first flexible sheet is rolled 8 from the open position shown in FIG. 2, which is completely flat, to the closed position in order to form a three-dimensional body closed laterally and open at least at one of the ends thereof. To assemble the trap 1 for trapping, once the base 4 has been mounted inside, an attractant diffuser 42 is deposited inside and a diffuser or insecticide tablet 44 such as vapona or the inside of the lid and/or the base is impregnated with a pyrethroid insecticide 44. Once this has been done, the operator places the lid 6 on the base 4 closing it by using the mutual coupling means, which in the case shown is simply a coupling by clamping between the top edge of the cone and the flap 40.

As also seen in the figures, the base 4 comprises a number of means 32 suitable for forming a side access entry to said chamber 2. In this first embodiment the means 32 consist of an entry orifice 14 for insects preformed in the first sheet 8 and which extends to form a frustoconical conduit 16 protruding from the main surface 18 of the first sheet 8.

This embodiment of the trap 1 is especially useful for frugivorous flying insects such as the Ceratis capitata or Dacus oleae. For this, the base 4 is opaque, while the lid 6 is translucent or transparent. Thus, once they have penetrated the chamber 2 this type of insect usually tries to find a way out through the translucent or transparent lid 6. This moves them away from the actual exit of the trap 1 via the conduits 16 and prolongs the length of time they remain in the chamber 2. The more time the fly is in the chamber 2, the more time there is for the insecticide to take effect, and therefore kill the insect.

It should be noted that the base 4 need not be completely opaque nor the lid 6 completely translucent or transparent. However, it seems particularly appropriate that, at a minimum, the area of the conduits 16 is opaque and in colours that attracts the target species.

In this embodiment, both the base 4 and the lid 6 are manufactured by thermoforming sheets of polyethylene terephthalate, better known in the art as PET, approximately 0.5 mm thick. First, this represents considerable savings of material in respect of known traps of the prior art that had been previously manufactured in thermoplastics such as injected polypropylene (PP). This therefore reduces the weight to be transported. However, in this type of product it is precisely the volume occupied which is the most critical parameter in respect of being able to market globally. Thus, as seen in FIG. 1, the base 4 is easily stackable by the frustoconical shaped conduits 16. Similarly, due to the cone taper, the lid 6 can also be easily stacked.

The first sheet 8 is smooth such that in its closed position the outer surface of the cone does not have sharp edges, in other words, the surface is substantially, completely smooth except for the seal line of the base 4. This prevents flies from taking flight once they land on the base 4.

It should also be mentioned that in this embodiment the thermoformed lid makes it difficult to hang the trap 1 from the fruit tree. To resolve this problem, the invention provides a hook 46 for hanging which ends in a hooked wire 48. The hook 46 can pierce the lid 6 and once inserted it remains in an inserted position 5 by means of the hooked wire 48. This hook may be made of wire, but it is preferably made of injected plastic, which reduces its weight and makes it easy to transport.

FIGS. 5 to 7 show a second embodiment of the trap 1, in which the base 4 further comprises a first flexible sheet 8 rolled to form a cylinder.

As shown in FIG. 5, in this case, the means 32 suitable for forming a side access entry to the chamber 2 are formed by previously punching the first sheet 8. Therefore, to create the orifices 14, a number of lateral conduits are provided 16 separate from the first sheet 8 and are angled at the end where they are inserted. In this way, in order to assemble trap 1, the operator must firstly pierce the means 32 with the angled end 50 of the conduit 16 and insert it until the rim 52 abuts the outer surface of the first sheet 8.

The base 4 further comprises a lower, hollow convex portion 20, in particular hemispherical, made from injected plastic. The first sheet 8 and the convex portion 20 are connected by means of a second mutual coupling means 22.

Unlike the first embodiment, the lid 6 of the trap 1 is simply a flat, flexible and transparent sheet 58 attached to the base 4 by means of the first coupling means 10. The flat sheet 58 that forms the lid 6 can be simply punched. It should be mentioned that in respect of the sheet of the lid 6 it could have a larger diameter than the cylinder of the base 4, to prevent water from penetrating into the trap 1 when it rains. Also alternatively, the bottom of the base could have a drainage passage, not shown in the figures, to prevent the accumulation of rain water.

FIGS. 8 and 10 show a third embodiment of the trap 1 according to the invention. In this case, the base 4 comprises an upper truncated cone 24 made from the first sheet 8 and which can be coupled to the lid 6 as explained above. Also as in the previous embodiment, the base 4 further has a lower, hollow convex portion 20.

FIGS. 9A and 9B explain the procedure for assembling the trap 1. Firstly, the conduits 16 are assembled on the first sheet 8. Then, the first sheet 8 is coupled to the convex portion 20 by inserting the tabs of the second coupling means 22 in the corresponding grooves provided in the first sheet 8. Once the first sheet 8 is rolled and assembled around the convex portion 20 of the base, the first closing means 12 are closed to complete the assembly of the base 4.

It is important to highlight that, particularly preferably, in the transition area 26 between the truncated cone 24 and the convex portion 20, the side surface of the base 4 is substantially smooth. By substantially smooth, it is understood that in the transition zone 26, steps larger than the thickness of the first sheet 8, which as mentioned is particularly thin, are not formed. It should be noted at this point that the first sheet 8 should be particularly thin and preferably less than 0.5 mm thick.

Also, although not shown in the figures, the convex portion 20 can be made by thermoforming to reduce the amount of material used during manufacturing.

The invention also aims to create a trap 1 which is particularly environmentally friendly. Therefore, preferably, all the parts which form the base 4 and the lid 6 are made from a biodegradable or biocompostable material such as cardboard or compounds derived from PLA (polylactic acid). If using materials such as cardboard as the first sheet 8 of this embodiment, it can be manufactured by stamping as it does not have preformed conduits 16. Preferably, the cardboard should be treated for protection against moisture to prevent the trap 1 from becoming damaged in the event of rain.

FIGS. 11A and 11B show a fourth embodiment of the invention. In this case, both the base 4 and the lid 6 are manufactured from first and second sheets 8, 30 that can be rolled respectively forming a cone. The second sheet 30, as in the first embodiment, is provided with second closing means 28 for securing the closed position of the cone. A particular characteristic in this embodiment is that the first and second starting sheets 8, 30, namely when the trap is unassembled, are identical as they are specularly symmetrical. The coupling means 10 between the lid 6 and the base 4 are formed by two tabs and two grooves such that when turning the base 4 90° relative to the lid 6 they can be easily fitted together. The trap 1 is particularly simple to manufacture since one same die can manufacture the lid 6 and the base 4.

In this case, storage and transport are extremely simple as the base 4 and the lid 6 are merely a plurality of stacked sheets, so as to reduce the transport volume to the absolute minimum.

In this embodiment the means 32 which are suitable for forming a side access entry to the chamber 2 simply comprise stamping on the sheets 8, 30. When mounting the trap 1, the operator simply has to pull the parts of the sheet that 35 open the orifices 14 of the base 4 and not pierce the second sheet 30 of the lid 6. In other words, in this case the trap 1 dispenses of the entry conduits rather than if they had other embodiments. However, and if necessary, additional tubes may also be assembled to form access conduits to the chamber 2.

For this embodiment it should be mentioned that it is not essential to the invention that the lid 4 and base 6 are identical. Optionally, and for those countries where the climate is humid, it is foreseen that the base of the cone of the lid 6 will be larger than the base of the cone of the base 4. In this way, the lid 6 overlaps the base 4 and protects it from the rain. Also as a result of this, a flap is formed which makes it difficult for the insects as they climb up the base 4 and get close to the lid 6 moving away from the orifices 14, as they come up against a barrier thanks to the flap of the lid 6.

For simplicity, FIGS. 12 to 14 show only the cutting plane. Nonetheless, these embodiments also comprise a sheet that can be rolled. As seen in the figures, these embodiments are particularly compact and can be easily transported, as the traps are manufactured exclusively from sheets that can be rolled or from folding laminar material. FIG. 12 shows a trap which is particularly useful for diptera such as Ceratis capitata. As shown, the base 4 is formed by a first sheet 8 that can be rolled which is a truncated cone whose smaller base forms the means 32 which are suitable for forming access entry, as the access opening 34 is formed once it has been rolled. The smaller base is positioned such that it points towards the inside of said chamber 2. In this case, the lid 6 is a second cone formed from a second sheet 30 which can be rolled. The trap 1 is assembled such that the smaller base of the truncated cone of the lid 4 points towards the apex of the second cone of the lid 6.

The embodiments of FIGS. 13 and 14 are particularly suitable for trapping Lepidoptera. Lepidoptera walk very little and it is advisable to make it easier for them to drop into the chamber 2. Therefore, the inner surface of the truncated cone which forms the lids 6 is smooth and slippery.

The trap 1 is virtually identical to that shown in FIG. 12, but its direction is reversed. Therefore, in this case, the lid 6 comprises a second flexible sheet 30 that can be rolled and is provided with second closing means, not shown in FIG. 13, to secure the closed position.

To prevent the accumulation of liquid in the trap 1 in this case the apex of the cone of the base 4 comprises an outlet 54 for liquid.

Finally, in the seventh embodiment of the trap 1 according to the invention, the second sheet 30 has a truncated cone and its smaller base forms an access opening 34 to the chamber 2. The smaller base is positioned such that it points towards the inside of the chamber 2. Additionally, the base 4 consists of a laminar receptacle 56 that can be folded like a bag.

What is claimed:

1. A method for monitoring electrical power consumption comprising:
identifying a plurality of electrical events corresponding to activation or deactivation of one of a predetermined number of electrical devices in a transformation of a time varying electrical power signal over a predetermined time period, the time varying electrical power signal supplying power to the predetermined number of electrical devices;
deconvolving the identified plurality of electrical events in the transformation of the time varying electrical power signal to generate a first plurality of signatures, each signature in the first plurality of signatures corresponding to activation of one electrical device in the predetermined number of electrical devices, and to generate a second plurality of signatures, each signature in the second plurality of signatures corresponding to deactivation of one electrical device in the predetermined number of electrical devices;
clustering the first plurality of signatures and second plurality of signatures to identify activations and deactivations of each electrical device in the predetermined number of electrical devices; and
identifying one electrical device in the predetermined number of electrical devices corresponding to one signature in the first clustered plurality of signatures and one signature in the second clustered plurality of signatures.

2. The method of claim 1, the transformation of the time varying electrical signal being a first derivative of the time varying electrical power signal.

3. The method of claim 1 further comprising:
identifying a signature that is generated with the deconvolution is in the first plurality of signatures in response to the signature having a positive value.

4. The method of claim 1 further comprising:
identifying a signature that is generated with the deconvolution is in the second plurality of signatures in response to the signature having a negative value.

5. The method of claim 1, wherein the deconvolution includes a penalty optimization to identify the first plurality of signatures and the second plurality of signatures.

6. The method of claim 4, wherein the penalty optimization includes a sparsity penalty term.

7. The method of claim 1, wherein the clustering of the first plurality of signatures and the second plurality of signatures is made with respect to a plurality of times at which each electrical device in the predetermined number of electrical devices is activated and deactivated.

8. The method of claim 1, wherein the clustering of the first plurality of signatures and the second plurality of signatures is made with respect to a frequency at which each electrical device in the predetermined number of electrical devices is activated and deactivated.

9. A system for monitoring electrical power consumption comprising:
an electrical power meter configured to measure a time varying electrical power signal that supplies power to a predetermined number of electrical devices; and
a processor operatively connected to the electrical power meter and configured to store data generated by the electrical power meter corresponding to the time varying electrical power signal in a memory, the processor being further configured to:
generate a transformation of the time varying electrical power signal with reference to the data stored in the memory corresponding to the time varying electrical power signal over a predetermined time period;
identify a plurality of electrical events corresponding to activation or deactivation of one of the predetermined number of electrical devices in the transformation of the time varying electrical power signal;
deconvolve the identified plurality of electrical events in the transformation of the time varying electrical power signal to generate a first plurality of signatures, each signature in the first plurality of signatures corresponding to activation of one electrical device in the predetermined number of electrical devices, and to generate a second plurality of signatures, each signature in the second plurality of signatures corresponding to deactivation of one electrical device in the predetermined number of electrical devices;
cluster the first plurality of signatures and second plurality of signatures to identify activations and deactivations of each electrical device in the predetermined number of electrical devices; and
identify one electrical device in the predetermined number of electrical devices corresponding to one signature in the first clustered plurality of signatures and one signature in the second clustered plurality of signatures.

10. The system of claim 9, the processor being further configured to:
generate the transformation of the time varying electrical power signal as a first derivative of the data stored in the memory corresponding to the time varying electrical power signal over the predetermined time period.

11. The system of claim 9, the processor being further configured to:
identify a signature that is generated with the deconvolution is in the first plurality of signatures in response to the signature having a positive value.

12. The system of claim 9, the processor being further configured to:
identify a signature that is generated with the deconvolution is in the second plurality of signatures in response to the signature having a negative value.

13. The system of claim 9, wherein the deconvolution includes a penalty optimization to identify the first plurality of signatures and the second plurality of signatures.

14. The system of claim 13, wherein the penalty optimization includes a sparsity penalty term.

15. The system of claim 9, wherein the processor clusters the first plurality of signatures and the second plurality of signatures with respect to a plurality of times at which each electrical device in the predetermined number of electrical devices is activated and deactivated.

16. The system of claim 9, wherein the processor clusters the first plurality of signatures and the second plurality of signatures with respect to a frequency at which each electrical device in the predetermined number of electrical devices is activated and deactivated.

17. The system of claim 9, wherein the time varying electrical power signal is an alternating current (AC) signal and the electrical power meter is further configured to measure a real component and a reactive component of the time varying electrical power signal.

18. The system of claim 17, wherein the processor is configured to generate the transformation of the data stored in the memory corresponding to the time varying electrical power signal with reference to a root mean square valuation of the real component and the reactive component of the time varying electrical power signal.

19. The system of claim 17, the processor being further configured to:
store the one signature in the first clustered plurality of signatures and the one signature in the second clustered plurality of signatures corresponding to the identified electrical device in the memory; and
identify at least one additional activation and deactivation of the identified electrical device that occurs after the predetermined time period with reference to the signatures stored in the memory.
